(19) United States
(12) Patent Application Publication
(10) Pub. No.: US 2026/0074581 A1
(43) Pub. Date: Mar. 12, 2026

(54) INTERNALLY MOUNTED ROTOR SHAFT AND ELECTRIC MACHINE WITH SUCH A ROTOR SHAFT

(71) Applicant: MAGNA Powertrain GmbH & Co KG, Lannach (AT)

(72) Inventors: Patrick KOLAR, Graz (AT); Michael DIENBAUER, Graz (AT); Christoph GSENGER, Graz (AT); Lukas GRAF, Graz (AT); Sebastian SCHILLER, Graz (AT)

(21) Appl. No.: 19/250,449

(22) Filed: Jun. 26, 2025

(30) Foreign Application Priority Data
Jul. 1, 2024 (DE) 102024118536.8

(51) Int. Cl. H02K 7/00; H02K 7/08

(52) U.S. Cl. CPC H02K 7/003; H02K 7/083

(57) ABSTRACT

A rotor shaft for a rotor of an electric machine, wherein the rotor shaft is constructed as a hollow shaft and thus has a cylindrical cavity for guiding a coolant, wherein at least one bearing for supporting the rotor shaft is arranged in the cavity, wherein at least one coolant outlet is formed at least between an outer lateral surface of the bearing and an inner lateral surface of the rotor shaft, and an electric machine comprising such a rotor shaft.

### CROSS-REFERENCE TO RELATED APPLICATIONS

This application claims priority to German Application No. DE 102024118536.8 filed on Jul. 1, 2024. The entire disclosure of the above application is incorporated herein by reference.

### FIELD OF THE INVENTION

The present invention relates to a rotor shaft for a rotor of an electric machine, wherein the rotor shaft is constructed as a hollow shaft and thus has a cylindrical cavity for guiding a coolant, wherein at least one bearing for supporting the rotor shaft is arranged in the cavity. In addition, the present invention relates to an electric machine comprising such a rotor shaft.

### BACKGROUND OF THE INVENTION

This section provides information related to the present disclosure which is not necessarily prior art.

Electric machines serve to convert electrical energy into mechanical energy and vice versa and are often employed as motors and/or generators in the field of automotive engineering.

Electric machines comprise a stationary stator and a movable rotor, wherein the rotor in the most common design of an electric machine is rotatably supported within an annular stator.

Electric machines generate heat during operation due to dielectric loss, which firstly causes the degree of efficiency of the electric machine to deteriorate, and secondly adversely affects the reliable operation of the electric machine over its service life. Therefore, a cooling system, which cools the parts to be cooled of the electric machine, is provided as a rule in drive arrangements comprising electric machines.

Conventional cooling systems for electric machines use a circulating gaseous or liquid coolant. The coolant circulates, for example, in a housing, the stator, the rotor of the electric machine and/or in a rotor shaft which is constructed as a hollow shaft and on which the rotor of the electric machine is arranged. Due to its heat capacity, the coolant absorbs the heat and carries it away.

In a rotor shaft cooling system, the efficiency of the cooling system greatly depends, inter alia, on how the coolant flows into the rotor shaft and how it is able to flow out of the rotor shaft. Additional power dissipated at the bearings for supporting the rotor shaft due to dissipation as heat has to be removed from the components by cooling the bearings appropriately.

### SUMMARY OF THE INVENTION

This section provides a general summary of the disclosure, and is not a comprehensive disclosure of its full scope or all of its features.

It is an object of the invention to specify an improved rotor shaft for a rotor of an electric machine. In addition, it is an object of the present invention to specify an improved electric machine.

This requirement can be fulfilled by the subject matter of a rotor shaft for a rotor of an electric machine, wherein the rotor shaft is constructed as a hollow shaft and thus has a cylindrical cavity for guiding a coolant, wherein at least one bearing for supporting the rotor shaft is arranged in the cavity, wherein at least one coolant outlet is formed at least between an outer lateral surface of the bearing and an inner lateral surface of the rotor shaft.

The object is further directed to an electric machine comprising a stationary, hollow cylindrical stator and a movable rotor, wherein the rotor is rotatably supported within the stator and has a rotor shaft constructed as detailed above.

The rotor shaft according to the invention for a rotor of an electric machine is constructed as a hollow shaft, wherein the rotor shaft thus has a cylindrical cavity for guiding a coolant.

According to the invention, at least one bearing for supporting the rotor shaft is arranged in the cavity. Such a bearing, that is to say a bearing arranged in the cavity of the rotor shaft, may also be referred to as an “internal bearing”.

According to the present invention, at least one coolant outlet is formed at least between an outer lateral surface of the bearing and an inner lateral surface of the rotor shaft.

The coolant outlet may be formed via the construction of the outer lateral surface of the bearing and/or the construction of the inner lateral surface of the rotor shaft or via an insert element arranged between the outer lateral surface of the bearing and the inner lateral surface of the rotor shaft.

The insert element is preferably produced from a polymer material, a metallic material, a ceramic material or a composite material.

The bearing is particularly preferably constructed as a rolling bearing.

The electric machine according to the invention comprises a stationary, hollow cylindrical stator and a movable rotor, wherein the rotor is rotatably supported within the stator and has a rotor shaft according to the invention.

An internally supported rotor shaft, i.e. a rotor shaft supported on at least one internal bearing, allows the rotor diameter to be increased and a smaller bearing to be installed, which has a positive effect on the degree of efficiency and the weight of a rotor or an electric machine comprising such a rotor. The coolant is in greater proximity to the magnets in the rotor and therefore ensures improved heat removal in regions with elevated magnet temperatures. The direct contact between the coolant and the bearing makes it possible to improve the cooling of the bearing. By propelling the outflowing coolant against housing components directly adjacent to the surroundings, it is possible to remove further heat from the system, thus further reducing the heat input into the cooling circuit.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a schematic sectional view of a rotor shaft.

FIG. 2 shows a sectional view along the sectional plane A-A as shown in FIG. 1.

### DESCRIPTION OF THE INVENTION

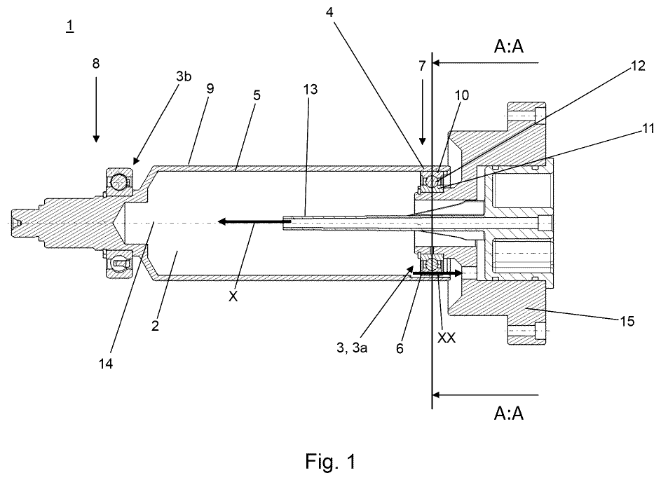

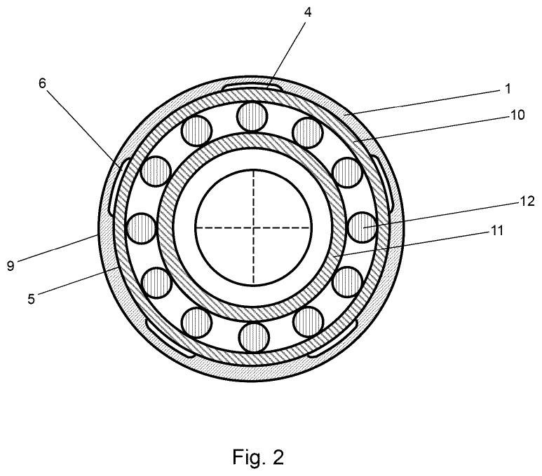

An exemplary embodiment of a rotor shaft 1 according to the invention is illustrated in FIGS. 1 and 2.

The rotor shaft 1 is formed as a hollow shaft and thus forms a central cavity 2. The rotor shaft 1 is open at a first end 7 and closed at a second end 8.

In addition, in the region of remote ends 7, 8, the rotor shaft 1 is supported on rolling bearings 3a, 3b, that is to say is supported at the first end 7 of the rotor shaft 1 on an internal rolling bearing 3a and is supported at the second end 8 of the rotor shaft 1 on an external rolling bearing 3b. In this context, the term “internal rolling bearing 3a” describes a bearing 3 which is arranged in the central cavity 2 of the rotor shaft 1, on an inner lateral surface 5 of the rotor shaft 1. In this context, the term “external rolling bearing 3b” describes a bearing which is arranged on an outer lateral surface 9 of the rotor shaft 1.

The internal rolling bearing 3a has an outer ring 10 and an inner ring 11, wherein a plurality of spherical rolling elements 12 are arranged between the outer ring 10 and the inner ring 11. The outer ring 10 of the internal rolling bearing 3a is constructed to be rotatable and the inner ring 11 of the internal rolling bearing 3a is constructed to be stationary, i.e. non-rotational, on a further component 15, in this case on a housing component. A plurality of coolant outlets 6 are formed between the outer lateral surface 4 of the internal rolling bearing 3a, or more precisely the outer ring 10 of the internal rolling bearing 3a, and the inner lateral surface 5 of the rotor shaft 1.

The coolant outlets 6 are basically formed via a guide-plate-like construction of the inner lateral surface 5 of the rotor shaft 1 and are delimited on one side by the outer lateral surface 4 of the internal rolling bearing 3a.

To cool the rotor shaft 1, the central cavity 2 of the rotor shaft 1 is connected to a coolant circuit (not illustrated). The flow directions of the coolant are illustrated schematically in FIG. 1 by arrows X, XX. The arrow X describes an inflow of coolant into the cavity 2 of the rotor shaft 1 and the arrow XX describes an outflow of coolant from the cavity 2 of the rotor shaft 1.

The coolant in the present case is oil.

The inflow of coolant into the central cavity 2 of the rotor shaft 1 is achieved via a cooling lance 13, through which coolant may be conducted into the central cavity 2 of the rotor shaft 1. The cooling lance 13 is supported in a rigidly fixed, i.e. non-rotational and axially fixed, manner in the further component 15 and passes axially through the further component 15.

The directional indication “axial” describes a direction along or parallel to a central axis 14 of rotation of the rotor shaft 1.

The cooling lance 13 is cylindrical and penetrates partially in an axial manner through the rotor shaft 1 formed as a hollow shaft.

By rotating the rotor shaft 1, the coolant is deposited as a film on the inner lateral surface 5 of the rotor shaft 1 and is guided out of the cavity 2 of the rotor shaft 1 via the coolant outlets 6 between the inner lateral surface 5 of the rotor shaft 1 and the outer lateral surface 4 of the internal rolling bearing 3a, or more precisely the outer ring 10 of the internal rolling bearing 3a.

Incorporating at least one additional flow-guiding component (not illustrated) on the inner lateral surface 5 of the rotor shaft 1 allows the coolant to be guided in a carefully controlled manner and thus allows the hydraulic flow to be improved and heat removal to be optimized.

A flow-guiding component is achieved, for example, via an additional geometric structure or guide plate on the inner lateral surface 5 of the rotor shaft 1, which can trigger an increase in pressure and thus achieve a pump effect which can overcome pressure losses which arise. Such a geometric shape or guide plate may extend over the entire inner lateral surface 5 of the rotor shaft 1 not covered by the internal rolling bearing 3a or be formed only partially over the inner lateral surface 5 of the rotor shaft 1 not covered by the internal rolling bearing 3a.

What is claimed is:

1. A rotor shaft for a rotor of an electric machine, wherein the rotor shaft is constructed as a hollow shaft and thus has a cylindrical cavity for guiding a coolant, wherein at least one bearing for supporting the rotor shaft is arranged in the cavity, wherein at least one coolant outlet is formed at least between an outer lateral surface of the bearing and an inner lateral surface of the rotor shaft.

2. The rotor shaft according to claim 1, wherein the coolant outlet is formed via the geometric construction of the outer lateral surface of the bearing and/or the geometric construction of the inner lateral surface of the rotor shaft or via an insert element arranged between the outer lateral surface of the bearing and the inner lateral surface of the rotor shaft.

3. The rotor shaft according to claim 2, wherein the insert element is produced from a polymer material, a metallic material, a ceramic material or a composite material.

4. The rotor shaft according to claim 1, wherein the bearing is constructed as a rolling bearing.

5. An electric machine comprising a stationary, hollow cylindrical stator and a movable rotor, wherein the rotor is rotatably supported within the stator and has a rotor shaft according to claim 1.
